(19) United States
(12) Patent Application Publication
(10) Pub. No.: US 2021/0382890 A1
(43) Pub. Date: Dec. 9, 2021

(54) METHOD, APPARATUS, DEVICE AND STORAGE MEDIUM FOR INFORMATION PROCESSING

(71) Applicant: NEC CORPORATION, Tokyo (JP)

(72) Inventor: Yu WU, Beijing (CN)

(73) Assignee: NEC CORPORATION, Tokyo (JP)

(21) Appl. No.: 17/336,882

(22) Filed: Jun. 2, 2021

(30) Foreign Application Priority Data
Jun. 3, 2020 (CN) 202010496598.3

(51) Int. Cl. G06F 16/2458; G06F 16/25; G06F 16/22

(52) U.S. Cl. CPC G06F 16/2465; G06N 20/00; G06F 16/2264; G06F 16/258

(57) ABSTRACT

The present disclosure relates to a method, apparatus, device and storage medium for information processing. Specifically, a method is proposed for information processing. In the method, multiple samples associated with multiple variables in an application system are obtained, each sample among the multiple samples comprising multiple dimensions, the multiple dimensions corresponding to the multiple variables, and the multiple variables involving multiple data types. An association associated with the multiple variables is determined from the multiple samples based on the multiple data types, the association indicating an associated relationship between any two variables among the multiple variables. Causality between the multiple variables is provided based on the association and the multiple samples. Further, there is provided an apparatus, device and storage medium for information processing. With example implementations of the present disclosure, the type of the multiple variables is not limited. In this way, the requirement on input data may be reduced, and data from more application systems may be processed.

### FIELD

Various implementations of the present disclosure relate to the field of machine learning, and more specifically, to a method, apparatus, device and computer storage medium for information processing based on machine learning technology.

### BACKGROUND

Machine learning technology has been widely applied in various fields so as to seek causality between multiple variables. For example, in the field of mechanical manufacture, part blanks have to undergo rough machining, finishing and grinding processes to produce parts that meet predetermined shape requirements. It will be understood that intermediate products of different quality levels might be produced in each process. The quality level of intermediate products will directly or indirectly determine whether final products are qualified. For another example, various transmission devices in a power transmission system might be in different operating states (for example, good, normal, abnormal, alarm, etc.). These states might directly or indirectly determine an output state of the power transmission system and/or power loss due to transmission.

Generally speaking, multiple variables may involve multiple types: continuous data type, ordinal data type, Boolean data type, censored data type, etc. Causality serves as a basis for other subsequent processing and analysis. How to determine more reliable causality based on collected data will affect the accuracy of subsequent operations to some extent. Therefore, it is desirable to provide a technical solution for determining causality, and it is desired that the technical solution may handle mixed data types and determine causality between multiple variables in a more accurate and effective way.

### SUMMARY

Example implementations of the present disclosure provide a technical solution for information processing.

According to a first aspect of the present disclosure, a method is proposed for information processing. In the method, multiple samples associated with multiple variables in an application system are obtained, each sample among the multiple samples comprising multiple dimensions, the multiple dimensions corresponding to the multiple variables, and the multiple variables involving multiple data types. An association associated with the multiple variables is determined from the multiple samples based on the multiple data types, the association indicating an associated relationship between any two variables among the multiple variables. Causality between the multiple variables is provided based on the association and the multiple samples.

According to a second aspect of the present disclosure, an apparatus is proposed for information processing. The apparatus comprises: an obtaining module configured to obtain multiple samples associated with multiple variables in an application system, each sample among the multiple samples comprising multiple dimensions, the multiple dimensions corresponding to the multiple variables respectively, and the multiple variables involving multiple data types; a determining module configured to determine an association associated with the multiple variables from the multiple samples based on the multiple data types, the association indicating an associated relationship between any two variables among the multiple variables; and a providing module configured to provide causality between the multiple variables based on the association and the multiple samples.

According to a third aspect of the present disclosure, an electronic device is proposed. The device comprises: at least one processing unit; at least one memory, coupled to the at least one processing unit and storing instructions to be executed by the at least one processing unit, the instructions, when executed by the at least one processing unit, causing the device to perform a method according to the first aspect.

According to a fourth aspect of the present disclosure, a computer-readable storage medium is provided, containing computer-readable program instructions stored thereon which are used to perform a method according to the first aspect.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the more detailed description in the accompanying drawings, features, advantages and other aspects of implementations of the present disclosure will become more apparent. Several implementations of the present disclosure are illustrated schematically and are not intended to limit the present invention. In the drawings:

FIG. 1A schematically shows a block diagram of one application environment in which example implementations of the present invention may be implemented;

FIG. 1B schematically shows a block diagram of another application environment in which example implementations of the present invention may be implemented;

FIG. 2 schematically shows a block diagram of a process of determining causality between multiple variables according to one implementation of the present disclosure;

FIG. 3 schematically shows a flowchart of a method for information processing according to one implementation of the present disclosure;

FIG. 4 schematically shows a block diagram of a process of determining an association between multiple variables according to one implementation of the present disclosure;

FIG. 5 schematically shows a block diagram of a method for determining an associated relationship between two variables among multiple variables according to one implementation of the present disclosure;

FIGS. 6A and 6B schematically show a block diagram of a process of determining causality between multiple variables by using a constraint-based solution according to one implementation of the present disclosure;

FIGS. 7A and 7B schematically show a block diagram of a process of determining causality between multiple variables by using a search-based solution according to one implementation of the present disclosure;

FIG. 8 schematically shows a block diagram of causality presented in a directed acyclic graph according to one implementation of the present disclosure;

FIG. 9 schematically shows a block diagram of an apparatus for information processing according to one implementation of the present disclosure; and

FIG. 10 shows a schematic block diagram of a device for information processing according to one implementation of the present disclosure.

### DETAILED DESCRIPTION OF IMPLEMENTATIONS

The preferred example implementations of the present disclosure will be described in more detail with reference to the drawings. Although the drawings illustrate the preferred example implementations of the present disclosure, it should be appreciated that the present disclosure can be implemented in various ways and should not be limited to the example implementations explained herein. On the contrary, these example implementations are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example implementation” and “one implementation” are to be read as “at least one example implementation.” The term “a further example implementation” is to be read as “at least a further example implementation.” The terms “first”, “second” and so on can refer to same or different objects. The following text also can comprise other explicit and implicit definitions.

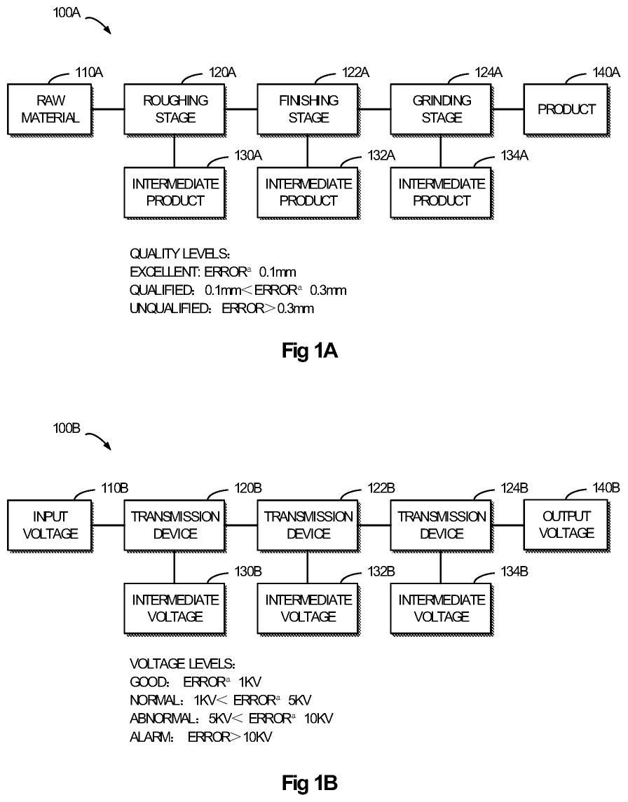

For the sake of description, first, a brief introduction is presented to an application environment of example implementations of the present disclosure, the application environment here involving mixed data types. Specifically, data types may comprise at least two of: ordinal data type, continuous data type, Boolean data type, censored data type, and so on. First of all, the meaning of ordinal data is introduced with reference to FIGS. 1A and 1B. FIG. 1A schematically shows a block diagram 100A of an application environment in which a method according to example implementations of the present disclosure may be implemented.

FIG. 1A shows multiple processing stages involved in a mechanical process. Suppose it is desirable to process a raw material 110A into a product 140A with a predefined size, and the raw material 110A may undergo a roughing stage 120A, a finishing stage 122A and a grinding stage 124A, respectively. At this point, intermediate products 130A, 132A and 134A may be formed after the roughing stage 120A, the finishing stage 122A and the grinding stage 124A, respectively. Since factors involved in the process of each part vary, intermediate products will have different quality levels. For example, excellent may indicate that the error of an intermediate product is ≤0.1 mm, qualified may indicate that the error of an intermediate product is >0.1 mm and ≤0.3 mm, and unqualified may indicate that the error of an intermediate product is >0.3 mm. These three levels may be denoted by integers 0, 1 and 2, respectively. It will be understood that quality levels of intermediate products in one processing stage have been shown for illustration purposes only, and thresholds for determining error levels in each stage may have the same or different values.

FIG. 1B schematically shows a block diagram 100B of a further application environment in which a method according to example implementations of the present disclosure may be implemented. FIG. 1B schematically shows a power transmission process. An input voltage 110B may be transmitted through transmission devices 120B, 122B and 124B, respectively, and then an output voltage 140B may be obtained. To reduce the loss during power transmission, ultra-high voltage circuit transmission mode can be used. An intermediate voltage 130B may be obtained at the transmission device 120B, an intermediate voltage 132B may be obtained at the transmission device 122B, and an intermediate voltage 134B may be obtained at the transmission device 124B. States of intermediate voltages may have different levels: good with voltage error ≤1 KV; normal with error >1 KV and ≤5 KV; abnormal with error >5 KV and ≤10 KV; alarm with error >10 KV. The four levels may be represented by integers 0, 1, 2 and 3, respectively. It will be understood that thresholds for determining error levels at each transmission device may have the same or different values.

The above quality levels of the intermediate products and the voltage levels belong to “ordinal data type.” Here ordinal data type represents statistical data, which uses levels to represent measured values. Ordinal data type has no measurement unit or absolute zero, but only has “equal to,” “not equal to” and “sequential relations” between them.

According to example implementations of the present disclosure, data types may comprise continuous data type. The continuous type is a quite common type in application environments. For example, in the application environment for the mechanical process as shown in FIG. 1A, the continuous type may be used to indicate sizes of parts. In the application environment for power transmission as shown in FIG. 1B, the continuous type may be used to indicate a distance of power transmission.

According to example implementations of the present disclosure, data types may comprise Boolean data type. For example, in the application environment for the mechanical process as shown in FIG. 1A, Boolean data 1 and 0 may be used to indicate the type of raw material (e.g., cooper and iron) and whether a product is qualified. In the application environment for power transmission as shown in FIG. 1B, Boolean data 1 and 0 may be used to indicate whether the power transmission system runs normally.

According to example implementations of the present disclosure, data types may comprise censored data type. Censored data refers to data which is truncated for some reason. Specifically, an example censored data C may be denoted as Formula 1 below:

$$C = \{ \begin{matrix}Y & if Y \leq τ \\ τ & if Y > τ\end{matrix} \qquad Formula 1$$

As shown in Formula 1, if data Y≤τ, then the value of the censored data C is Y; if data Y<τ, then the value of the censored data C is τ. It will be understood that the inequality here is merely for the illustration purpose, and the inequality in other example may use a different direction.

In the application environment for the mechanical process as shown in FIG. 1A, an optical sensor may be used to measure the smoothness of parts. When the luminous flux is less than a certain threshold, it cannot reach the detectable threshold of the optical sensor. At this point, the measurement result is considered as 0. When the luminous flux is greater than the threshold, the optical sensor operates normally and may output a measurement result. In the application environment for power transmission as shown in FIG. 1B, censored data may be used to represent the current of the transmission device. When the current is lower than a certain threshold, the transmission device cannot be started normally, and at this point, the current equals 0; when the current is higher than the threshold, then the transmission device starts working, and the current at the transmission device may be measured.

According to one technical solution, causality between variables of a single data type may be determined. However, in an actual application environment, many variables relate to mixed data types, which results in that existing technical solutions based on a single data type cannot work effectively. According to another technical solution, a technique has been proposed for determining causality between variables of the continuous type and ordinal type. However, the technique has low precision and cannot accurately describe causality between multiple variables. Further, the technique also cannot determine mixed data types that comprise more types. Therefore, it is desirable to determine causality between multiple variables that comprise mixed data types in a more accurate and effective way.

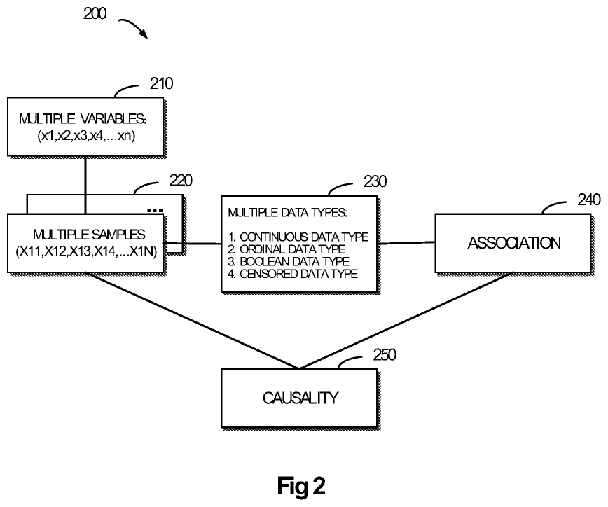

To at least partly solve the drawbacks in the above technical solutions, a method for information processing is provided according to example implementations of the present disclosure. First with reference to FIG. 2, a brief description is presented to example implementations of the present disclosure. FIG. 2 schematically shows a block diagram 200 of the process of determining causality between multiple variables according to one implementation of the present disclosure.

According to example implementations of the present disclosure, there is proposed for determining an association between multiple variables based on data types of the multiple variables. Specifically, multiple variables 210 may be collected from the application system. Suppose the number of multiple variables is denoted as n, then the multiple variables may be denoted as x₁, x₂, x₃, x₄, . . . , xₙ. Here, the multiple variables 210 may involve multiple data types 230. In other words, in the context of the present disclosure, the multiple variables involve mixed data types and at least comprise two data types. For example, variable x₁ may be represented as continuous data type, variable x₂ may be represented as ordinal data type, variables x₃ and xₙ may be represented as Boolean data types, and variable x₄ may be represented as censored data type.

Multiple samples 220 associated with the multiple variables 210 in the application system may be obtained. Here, each sample among the multiple samples comprises multiple dimensions that correspond to the multiple variables respectively. As shown in FIG. 2, a sample may be represented as (X11, X12, X13, X14, . . . , X1n). Each dimension in the sample may correspond to one variable among the multiple variables. For example, data X11 at the 1^{st} dimension corresponds to variable x₁, data X12 at the 2^{nd} dimension corresponds to variable x₂, etc. An association 240 associated with the multiple variables may be determined from the multiple samples 220 based on the multiple data types. Here, the association 240 may represent an associated relationship between any two variables among the multiple variables 210. Subsequently, the causality 250 between the multiple variables 210 may be provided based on the multiple samples 220 and the association 240.

It will be understood that a large number of variables in the application system may comprise multiple data types, and these variables may have complicated causality. With example implementations of the present disclosure, it is possible to determine the association between the multiple variables based on the data types of the variables in a more accurate way. Further, it is possible to improve the accuracy of the causality between the multiple variables based on a more accurate association. Compared with existing technical solutions that only can process variables of a specified data type, the type of the multiple variables is not limited with example implementations of the present disclosure. In this way, the requirement on sample data may be reduced, and data from more application systems may be processed.

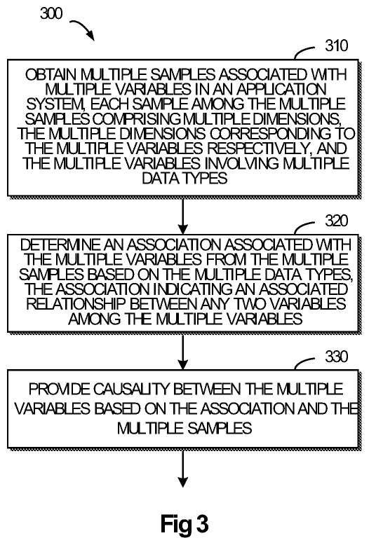

With reference to FIG. 3, description is presented below to more details about example implementations of the present disclosure. FIG. 3 schematically shows a flowchart of a method 300 for information processing according to one implementation of the present disclosure. At block 310, multiple samples 220 associated with multiple variables 210 in the application system are obtained, each sample among the multiple samples 220 comprising multiple dimensions. Here, the multiple dimensions correspond to the multiple variables 210 respectively, and the multiple variables 210 involve multiple data types.

According to example implementations of the present disclosure, the multiple data types 230 may comprise at least two of: continuous data type, ordinal data type, Boolean data type and censored data type. It will be understood that these data types cover most of data types in daily application systems. Therefore, with example implementations of the present disclosure, it is possible to process more types of input data and further significantly expand the application scope of the technical solution according to example implementations of the present disclosure.

According to example implementations of the present disclosure, a data type among the multiple data types 230 corresponds to a monotonic function. It will be understood that in the context of the present disclosure, comparison operations will be involved, so each data type is required to correspond to a monotonic function.

More details about the multiple variables 210 and the multiple samples 220 will be described with reference to the application environments shown in FIG. 1A and FIG. 1B respectively. In the application system for mechanical manufacture as shown in FIG. 1A, the multiple variables 210 may comprise multiple attributes of the application system. For example, variables x₁ to x₃ may represent the quality level, part size and smoothness in the grinding stage, variable x₄ represents the raw material of a part, and variable x₅ represents whether the product is qualified. At this point, each sample may comprise multiple data corresponding to the above variables. Examples of the multiple samples are schematically shown in Table 1 below.

TABLE 1
Examples of Multiple Samples

| variable x₁ | | variable x₃ | | |
|---|---|---|---|---|
| (quality | variable x₂ | (smooth- | | variable x₅ |
| levels in | (sizes in | ness | variable x₄ | (whether |
| grinding | grinding | in grinding | (raw | products |
| stage) | stage) | stage) | material) | are qualified) |
| X11 | X12 | X13 | X14 | X15 |
| X21 | X22 | X23 | X24 | X25 |
| . . . | . . . | . . . | . . . | . . . |
| Xm1 | Xm2 | Xm3 | Xm4 | Xm5 |

In Table 1, variables x₁ to x₃ represent the quality level, part size and smoothness in the grinding stage, wherein the quality level is denoted as ordinal data type, the part size is denoted as continuous data type, and the smoothness is denoted as censored data type. Variable x₄ represents the raw material of parts, variable x₅ represents whether products are qualified, and these two variables are both denoted as Boolean data type.

Suppose the number of the collected multiple samples 220 is m, and each row in Table 1 represents one sample. The first row shows samples of the first part in the process, i.e., data X11, X12 and X13 in the first 3 dimensions correspond to the quality level, part size and smoothness in the grinding stage respectively. Data X14 in the 4^{th} dimension corresponds to the raw material, and data X15 in the last dimension corresponds to a fact whether the final product is qualified. Similarly, the m^{th} row shows samples of the m^{th} part in the process. It will be understood that Table 1 merely illustrates an example data structure of the sample, and according to example implementations of the present disclosure, there may exist more variables. For example, there may be comprised the quality levels, sizes and smoothness of parts in the roughing stage and the finishing stage. Moreover, there may exist less variables according to example implementations of the present disclosure.

It will be understood that Table 1 merely illustrates an example data structure of the sample in the application system as shown in FIG. 1A. In other application systems, the sample may comprise more, less or different dimensions. For example, in the power transmission system shown in FIG. 1B, variables x₁ to x₃ may represent voltage levels at 3 transmission devices (denoted as ordinal data type), variable x₄ may represent a working state of the power system (denoted as Boolean data type), variable x₅ may represent the current (denoted as censored data type), and variable x₆ may represent power loss (denoted as continuous data type).

After the multiple samples 220 are collected, they may be processed so as to obtain an association 240 of the multiple variables 210. Still with reference to FIG. 3, at block 310, the association 240 associated with the multiple variables 210 is determined from the multiple samples 220 based on the multiple data types. According to example implementations of the present disclosure, the association 240 represents an associated relationship between any two variables among the multiple variables 210. Multiple data structures may be used to represent the association 240. According to example implementations of the present disclosure, the association 240 may be denoted as a matrix E as shown in Formula 2 below.

$$\sum = \{ \begin{matrix}{ρ}_{11} & {ρ}_{12} & … & {ρ}_{1 n} \\ {ρ}_{21} & {ρ}_{22} & … & {ρ}_{2 n} \\ … & … & … & … \\ {ρ}_{n 1} & {ρ}_{n 2} & … & {ρ}_{n n}\end{matrix} \} \qquad Formula 2$$

where matrix Σ denotes the association 240 between the multiple variables 210, dimensions of the matrix may be denoted as n×n, n denotes the number of the multiple variables 210, and each element in the matrix denotes an associated relationship between two variables associated with a position of the element. In the matrix representation Z of the association 240, an element beyond the diagonal represents an associated relationship between the multiple ordinal data. Specifically, element p₁₂ in the matrix represents the associated relationship between the 1^{st} variable and the 2^{nd} variable among the multiple variables 210, and element ρᵢⱼ in the matrix represents the associated relationship between the i^{th} variable and the j^{th} variable among the multiple variables 210 (i≠j).

It will be understood that Formula 2 is merely one specific example of the representation of the association 240. According to example implementations of the present disclosure, the association 240 may be represented based on arrays, tables, linked lists and other way.

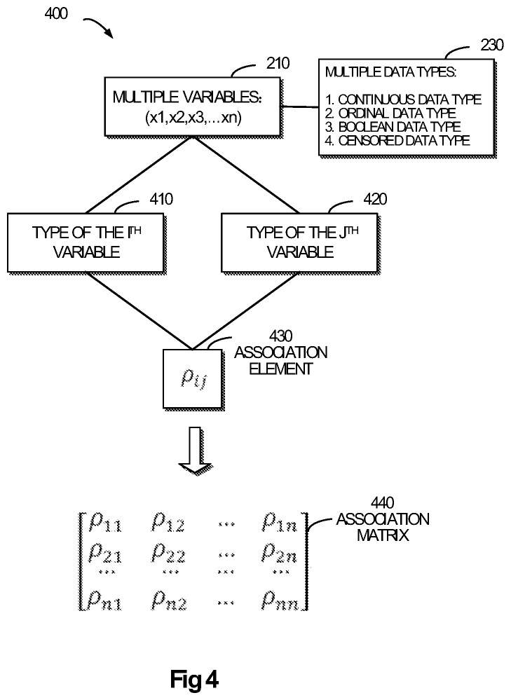

With reference to FIG. 4, description is presented below to more details on how to determine the association 240 between the multiple variables 210. FIG. 4 schematically shows a block diagram 400 of a process of determining the association 240 between the multiple variables 210 according to one implementation of the present disclosure. As depicted, each pair of variables among the multiple variables 210 may be processed one after another. According to example implementations of the present disclosure, two variables may be selected from the multiple variables 210, for example, the i^{th} variable and the j^{th} variable may be selected from the multiple variables 210. Subsequently, the types of the two variables may be determined. For example, an association element 430 (denoted as symbol ρᵢⱼ) in the association 240 which represents the associated relationship between the i^{th} variable and the j^{th} variable may be determined based on a type 410 of the i^{th} variable and a type 420 of the j^{th} variable. Each pair of variables among the multiple variables 210 may be traversed so as to determine the corresponding association element 430. Further, an association matrix 440 among the multiple variables 210 may be determined based on the association element 430 for each pair of variables.

It will be understood that the data type of each variable may come from any of continuous data type, ordinal data type, Boolean data type and censored data type. Therefore, types of one pair of variables may have different combinations. It will be understood that Boolean data type only comprises values 0 and 1, so Boolean data type may be considered as a special ordinal data type. At this point, data types of variables comprise 3 data types, i.e., continuous data type, ordinal data type and censored data type.

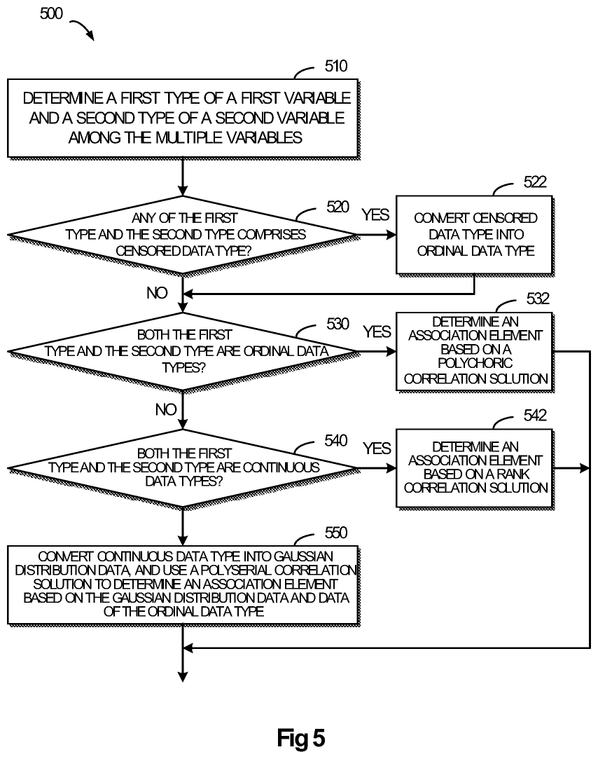

With reference to FIG. 5, description is presented below to more details on how to determine the association element 430 based on data types of two variables. FIG. 5 schematically shows a block diagram of a method 500 for determining an associated relationship between two variables among multiple variables according to one implementation of the present disclosure. At block 510, a first type of a first variable and a second type of a second variable may be determined respectively. Suppose input data is the i^{th} variable and the j^{th} variable among the multiple variables 210, then the type 410 of the i^{th} variable and the type 420 of the j^{th} variable may be determined respectively.

It will be understood that censored data type represents truncated data and has a value range, so this data type may be converted into censored data type. At block 520, first it may be determined whether the two types 410 and 420 comprise the censored data type. If any of the types 410 and 420 is censored data type, then the method 500 may proceed to block 522 so as to convert data of censored data type into ordinal data type. With example implementations of the present disclosure, censored data type may be converted into ordinal data type, so the number of data types may further be reduced and the multiple samples 220 may be processed in a simpler and more effective way.

According to example implementations of the present disclosure, the conversion may be implemented based on the concept of quantile. It will be understood that the quantile refers to dividing the probability distribution range of a variable into multiple equal numerical points. Commonly used quantiles include medians (that is, the second quartile), quartiles, percentiles, etc. First, a first dimension among the multiple samples 220 which corresponds to the first variable may be determined. Suppose the i^{th} variable among the multiple variables 210 is censored data type, then data in the i^{th} dimension among the multiple samples is of censored data type. Where there exist m samples, m data will be obtained.

A specific operation will be described by taking a median as an example. m data may be sorted in the ascending order. If m is an odd number, then data in the middle of the sorting of m data is the median. If m is an even number, the average of the two data in the middle of the sorting of m data may be used as the median. Subsequently, m data may be divided into two parts based on the median. According to example implementations of the present disclosure, the minimum value of m data may be used to represent one or more data less than the median, and the median may be used to represent one or more data greater than or equal to the median.

It will be understood that the foregoing expression is merely schematic, and according to example implementations of the present disclosure, the maximum value of m data may be used to represent one or more data greater than the median, and the median may be used to represent one or more data less than or equal to the median. According to example implementations of the present disclosure, the average may be used to represent one or more data on two sides of the median in the sorting. According to example implementations of the present disclosure, m data may further be sorted in descending order.

It will be understood that description on how to convert m data into ordinal data type comprising two levels has been described by taking the median as an example. According to example implementations of the present disclosure, m data may be converted into ordinal data type comprising more levels in a similar way. If it is desirable to convert m data into ordinal data type comprising 4 levels, then 1/4 quantile, 2/4 quantile and 3/4 quantile may be determined, and then based on these three quantiles, m data may be converted into ordinal data type comprising 4 levels.

With example implementations of the present disclosure, it is possible to convert censored data type into ordinal data type that is easier to process, in a simple and effective way. Thus, the difficulty of subsequent information processing may be lowered, and further the performance of the information processing method may be increased.

According to example implementations of the present disclosure, it is possible to determine how many levels are comprised in ordinal data, according to a specific application environment. For example, if the number of m data is large, then m data may be converted into ordinal data comprising more levels. If m data covers a larger range of values, then m data can be converted into ordinal data comprising more levels. Here ordinal data comprising more levels may increase the data representation precision. For another example, if the number of m data is small and covers a smaller range of values, then m data may be converted into ordinal data comprising fewer levels. Here ordinal data comprising fewer levels may reduce the computation load for subsequent data processing.

With example implementations of the present disclosure, the conversion precision may be determined based on parameters of a specific application environment. In this way, a balance may be maintained between the data representation precision and the computation load, so as to increase the overall performance of the information processing technical solution.

In one example, it is desirable to convert m data into ordinal data comprising 8 levels. Then 7 quantiles associated with 7 (8−1=7) levels may be determined respectively: 1/8 quantile, 2/8 quantile, . . . , and 7/8 quantile. Subsequently, m data in the i^{th} dimension may be converted into ordinal data based on the 7 quantiles. In another example, m data may be converted into ordinal data comprising other levels, based on other quantiles. For example, m data may be converted into ordinal data comprising 100 levels, based on percentiles.

Still with reference to FIG. 5, at block 520, if neither the first type nor the second type involves censored data type, then the method 500 proceeds to block 530. It will be understood that censored data type among the multiple variables has been converted into ordinal data type through the convert operation at block 522. At this point, the multiple variables comprise only two types: the ordinal data type and the continuous data type. At this point, types of a pair of variables will involve 3 situations: two ordinal data types, two continuous data types, and one ordinal data type and one continuous data type.

At block 530, if it is determined that both the first type and the second type are ordinal data types, then the method 500 proceeds to block 532, so as to determine the association element based on a polychoric correlation solution. It will be understood that the polychoric correlation solution is an effective technical solution which has been proposed for determining the association between two variables of ordinal data type. For specific details about the technical solution, reference may be made to Maximum Likelihood Estimation of the Polychoric Correlation Coefficient by Ulf Olsson.

With example implementations of the present disclosure, the process of determining the associated relationship between two variables may be divided into different branches based on types of the two variables. In this way, it is possible to make full use of the polychoric correlation solution to determine the associated relationship between two variables of the ordinal data type.

At block 530, if the judgment result is “No,” then the method 500 proceeds to block 540 so as to determine whether the first type and the second type are both continuous data type. At block 540, if it is determined that both the first type and the second type are continuous data type, then the method 500 proceeds to block 542 so as to determine the association element based on a rank correlation solution. It will be understood that the rank correlation solution is an effective technical solution which has been proposed for determining the association between two variables of continuous data type. For specific details about the technical solution, reference may be made to Formulas 4 and 5 in PC Algorithm for Nonparanormal Graphical Models by Naftali Harris, et al.

With example implementations of the present disclosure, the process of determining the associated relationship between two variables may be divided into different branches based on types of the two variables. In this way, it is possible to make full use of the rank correlation solution to determine the associated relationship between two variables of continuous data type.

At block 540, if the judgment result is “No,” then the method 500 proceeds to block 550. At this point, continuous data type may be converted into Gaussian distribution data. For example, continuous data type may be converted into Gaussian distribution based on Formula 6 in Nonparanormal: Semiparametric Estimation of High Dimensional Undirected Graphs by Han Liu, et al. Subsequently, the association element between data of the first type and the second type may be determined using the polyserial correlation solution based on Gaussian distribution data and data of the ordinal data type.

It will be understood that the polyserial correlation solution is an effective technical solution which has been proposed so far. For specific details about the technical solution, reference may be made to polychoric and polyserial correlations by Fritz Drasgow. With example implementations of the present disclosure, the process of determining the associated relationship between two variables may be divided into different branches based on types of the two variables. In this way, it is possible to make full use of Gaussian distribution and polyserial correlation solution to determine the associated relationship between variables of ordinal data type and continuous data type.

Details on how to determine the association 240 between the multiple variables 210 based on types of the multiple variables 210 has been presented above. Now returning to FIG. 3, description is presented on how to determine the causality 250 between the multiple variables 210.

At block 330, the causality 250 between the multiple variables 210 is provided based on the association 240 and the multiple samples 220. According to example implementations of the present disclosure, the causality 250 may be provided in various ways. According to example implementations of the present disclosure, the causality 250 between the multiple variables 210 may be provided by using a constraint-based solution. Typical constraint-based technical solutions mainly comprise PC (Peter-Clark) algorithm and Inductive Causation algorithm, etc.

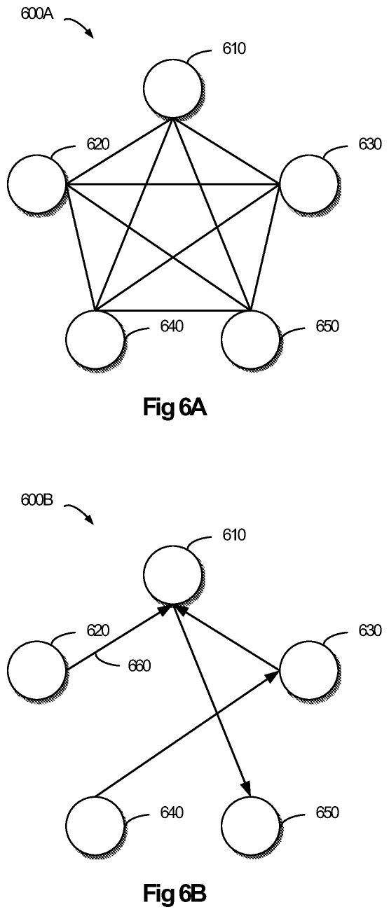

The constraint-based technical solution mainly comprises an undirected graph learning stage and a directed learning stage. Hereinafter, the two stages will be described with reference to FIG. 6A and FIG. 6B respectively. FIG. 6A schematically shows a block diagram 600A of a process of determining causality between multiple variables based on a constraint-based solution according to one implementation of the present disclosure. As depicted, in the undirected learning stage, a fully connected graph may first be constructed as shown in FIG. 6A. Nodes 610, 620, 630, 640 and 650 denote the multiple variables x₁, x₂, x₃, x₄, and x₅ respectively. Based on the association 240 and independence between variables given by statistical methods such as independence or conditional independence hypothesis testing, edges between variables without causality may be removed from the fully connected graph so as to obtain the undirected graph between among the multiple variables.

FIG. 6B schematically shows a block diagram 600B of a process of determining causality between multiple variables based on a constraint-based solution according to one implementation of the present disclosure. As depicted, in the directed learning stage, a direction of an edge between nodes is determined depending on local structural characteristics such as V-structure. At this point, the causality between the variables x₁, x₂, x₃, x₄, and x₅ may be obtained. If two nodes have an edge between them, this means the two variables have causality; otherwise, the two variables do not have causality. The direction of the edge indicates a direction in which the causality propagates. For example, an edge 660 points from a node 620 to a node 610, which means that the variable x₂ is the direct cause of the variable x₁. Similarly, the causality between the multiple variables 210 may be determined.

It will be understood that FIGS. 6A and 6B merely illustrate specific examples of determining the causality between the variables x₁, x₂, x₃, x₄, and x₅ by using the PC solution. According to example implementations of the present disclosure, the multiple variables may have different numbers, so different undirected graphs and directed graphs may be obtained in two stages of the PC solution.

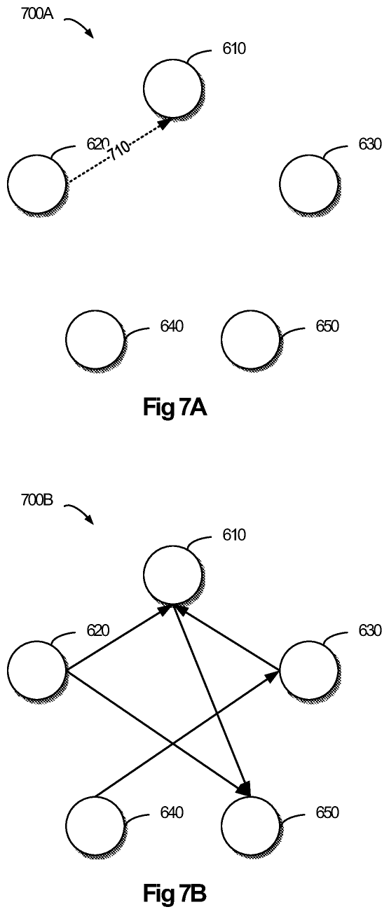

According to example implementations of the present disclosure, the causality 250 between the multiple variables 210 may be provided by using a search-based solution. Various search-based solutions have been developed so far, for example, Greedy Equivalence Search (GES) solution is a relatively effective search solution. In the technical solution, starting from an initial set, directed edges may be constantly added to a directed edge set, and an objective function may be set based on the association 240 so as to determine whether to keep the added direction edge. FIG. 7A schematically shows a block diagram 700A of a process of determining causality between multiple variables based on a search-based solution according to one implementation of the present disclosure. As depicted, starting from an empty set, a directed edge 710 may be added to the directed edge set; if the directed edge 710 satisfies the objective function, then the edge is kept in the directed edge set.

Subsequently, another edge may be added to the directed edge set. FIG. 7B schematically shows a block diagram 700B of a process of determining causality between multiple variables based on a search-based solution according to one implementation of the present disclosure. Suppose the directed graph as shown in FIG. 7B may maximize the objective function, at this point the directed graph may be used as the causality 250.

It will be understood that the constraint-based solution and the search-based solution are merely two specific examples for determining the causality 250. According to example implementations of the present disclosure, the causality 250 between the multiple variables 210 may be provided based on the association 240 according to another solution that has been developed and/or will be developed in future. With example implementations of the present disclosure, it is possible to make full use of the technical solution, which has been proved as effective, to obtain the final causality 250.

Usually, as measured values of the multiple variables have been observed for a long time, some experience might have been accumulated as to whether two variables have causality. A constraint on the causality between two variables may be referred to as expert knowledge. At this point, the expert knowledge may be introduced to the process of determining the causality 250. The expert knowledge may be received and applied to different stages for determining the causality 250. For example, in the constraint-based technical solution, the expert knowledge may be used to remove edges from the fully connected graph. In the search-based technical solution, the expert knowledge may be used to construct the initial set of directed edges and/or select to-be-added edges. After the causality 250 is obtained, the expert knowledge may be used to verify whether the obtained causality 250 conforms to known experience. It will be understood that since the expert knowledge reflects professional experience accumulated by people, by determining the causality 250 based on the expert knowledge, on the one hand it is possible to reduce the amount of calculation in the process, and on the other hand, it is possible to cause the obtained causality 250 to better conform to the historical experience.

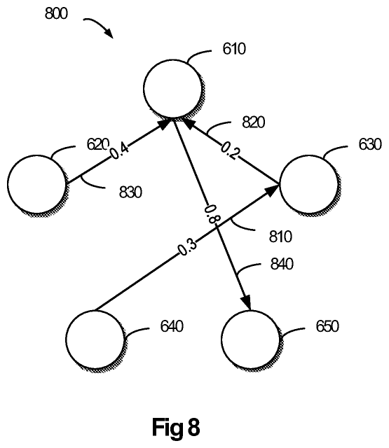

Description has been presented on how to determine the causality 250. According to example implementations of the present disclosure, the found causality 250 may be presented in various ways. For example, the causality may be presented in a directed acyclic graph (DAG). Specifically, FIG. 8 schematically shows a block diagram 800 of causality presented in a directed acyclic graph according to one implementation of the present disclosure. As depicted, nodes 610 to 650 represent the multiple variables x₁ to x₅, respectively. An edge in the graph indicates that two ordinal data have direct causality. For example, an edge 810 indicates that variable x₄ is the direct cause of variable x₃ and a weight of the causality is 0.3; an edge 8120 indicates that variable x₃ is the direct cause of variable x₁ and a weight of the causality is 0.2; an edge 830 indicates that variable x₂ is the direct cause of variable x₁ and a weight of the causality is 0.4; and an edge 840 indicates that variable x₁ is the direct cause of variable x₅ and a weight of the causality is 0.8.

According to example implementations of the present disclosure, the found causality 250 may be presented in a matrix. At this point, multiple dimensions of the matrix represent the multiple variables, respectively, and an element of the matrix represents a weight of causality between two variables corresponding to two elements among the multiple variables. The causality 250 may be presented based on a matrix M below, and the matrix M represents the same causality 250 as the DAG shown in FIG. 8.

$$M = [ \begin{matrix}0 & 0 & 0 & 0 & 0.8 \\ 0.4 & 0 & 0 & 0 & 0 \\ 0.2 & 0 & 0 & 0 & 0 \\ 0 & 0 & 0.3 & 0 & 0 \\ 0 & 0 & 0 & 0 & 0\end{matrix} ]$$

With example implementations of the present disclosure, presenting the found causality 250 in the DAG or the matrix may facilitate administrators of an application system to understand causality between multiple variables included in the application system, so as to further adjust operations of the application system based on the found causality 250.

According to example implementations of the present disclosure, the multiple variables may represent multiple attributes of the application system. For example, in the above example, variables x₁, x₂ and x₃ represent the quality level, part size and smoothness in the grinding stage, variable x₄ represents the raw material of a part, the variable x₅ represents whether a product is qualified. According to example implementations of the present disclosure, data of multiple dimensions included in a given sample may be received from multiple sensors which are deployed in the application system. For example, regarding the first sample in Table 1, data X11, X12 and X13 may be collected from measurement sensors deployed at a grinding device in the machining system. With example implementations of the present disclosure, samples may be collected from existing sensors in the application system without deploying an extra sensor. In this way, the reuse performance of sensors in the application system may be increased.

According to example implementations of the present disclosure, a value of the variable may be directly obtained. Alternatively and/or additionally, continuous data may be obtained first, and then a specific value of the variable may be obtained based on the processing of the continuous data (e.g., divided by a threshold).

According to example implementations of the present disclosure, operations of the applications system may be adjusted based on the obtained causality 250. According to example implementations of the present disclosure, failures in the application system may further be eliminated based on the causality. Specifically, regarding the machining system shown in FIG. 1A, causality between respective attributes and whether the produce is qualified has been determined based on the above method. The attribute that most affects unqualified products may be adjusted first based on the found causality.

According to example implementations of the present disclosure, the performance of the application system may be improved based on the causality 250. Specifically, cause nodes in the causality 250 of the application system may be affected by adjustment, monitoring and other means, and then the performance of the application system may be improved. In addition, the improvement or performance boost of the application system may be promoted by automatically outputting the analysis result (the causality 250) if a predetermined condition is met. As an example, for the power transmission system shown in FIG. 1B, suppose that causality between the intermediate voltages at respective transmission devices, the working state of the transmission system, current and power loss has been determined based on the above method, then the variable that exerts the greatest impact on power loss may be adjusted first based on the found causality. In this way, the performance of the power transmission system may be increased.

It will be understood although how to determine causality between multiple variables involving mixed data types has been described by taking the machining system and the power transmission system as specific examples of the application system, the method 300 according to example implementations of the present disclosure may further be applied in other types of application systems. According to example implementations of the present disclosure, in a product analysis system, questionnaires may be issued to users, and various attributes (for example, price, taste, product price, user age, user gender, etc.) of a certain product and results of and users' purchase intentions may be collected.

Specifically, the price and taste may be represented using ordinal data (a score between 1 and 5), product price may be represented using continuous data, user age may be represented using censored data (the age under 18 is denoted as 18 years old, the age over 18 is denoted as the actual age), and user gender is represented using Boolean data (0 represents female, and 1 represents male). At this point, a product attribute that most affects the purchase intention may be determined, which helps to improve the product quality and increase the product sales. In addition, the analysis performance of the product analysis system may be increased based on updated product attributes which are further received.

Further, the method may comprise regularly or irregularly receiving/obtaining variables of the application system so as to continuously update or improve the causal structure analysis.

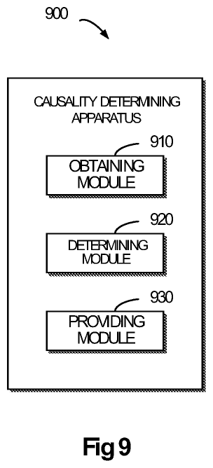

Details about the method for determining the causality have been described with reference to FIGS. 2 to 8. Hereinafter, various modules in an apparatus for determining causality will be described with reference to FIG. 9. This figure schematically shows a block diagram of an apparatus 900 for information processing according to one implementation of the present disclosure. The apparatus 900 comprises: an obtaining module 910 configured to obtain multiple samples associated with multiple variables in an application system, each sample among the multiple samples comprising multiple dimensions, the multiple dimensions corresponding to the multiple variables respectively, and the multiple variables involving multiple data types; a determining module 920 configured to determine an association associated with the multiple variables from the multiple samples based on the multiple data types, the association indicating an associated relationship between any two variables among the multiple variables; and a providing module 930 configured to provide causality between the multiple variables based on the association and the multiple samples.

According to example implementations of the present disclosure, the multiple data types comprise at least two of: continuous data type, ordinal data type, Boolean data type and censored data type.

According to example implementations of the present disclosure, the determining module 920 comprises: a type determining module configured to determine a first type of a first variable and a second type of a second variable among the multiple variables; and an element determining module configured to determine an association element in the association which indicates an associated relationship between the first variable and the second variable, based on the first type and the second type.

According to example implementations of the present disclosure, the element determining module comprises: a type converting module configured to convert data, which corresponds to the first variable, in the multiple samples into the ordinal data type in response to the first type being determined as censored type.

According to example implementations of the present disclosure, the type converting module comprises: a dimension determining module configured to determine a first dimension, which corresponds to the first variable, in the multiple samples; and a data converting module configured to convert data in the first dimension into the censored data type according to a quantile in the data in the first dimension in the multiple samples.

According to example implementations of the present disclosure, the data converting module comprises: a level determining module configured to determine the number of levels included in the censored data type according to at least any of: the number of the multiple samples and a range of the data in the first dimension; a quantile determining module configured to determine at least one quantile associated with the number of the levels; and a data type converting module configured to convert the data in the first dimension into the censored data type based on the at least one quantile.

According to example implementations of the present disclosure, the element determining module comprises: a continuous data processing module configured to determine the association element based on a rank correlation solution in response to both the first type and the second type being determined as continuous data type.

According to example implementations of the present disclosure, the element determining module comprises: a censored data processing module configured to determine the association element based on a polychoric correlation solution in response to both the first type and the second type being determined as ordinal data type.

According to example implementations of the present disclosure, the element determining module comprises a mixed data processing module configured to: in response to the first type being determined as continuous data type and the second type is determined as ordinal data type, convert data, which corresponds to the first variable, in the multiple samples into Gaussian distribution data; and use a polyserial correlation solution to determine the association element based on the Gaussian distribution data and data of the ordinal data type.

According to example implementations of the present disclosure, the providing module 930 comprises at least one of: a constraint-based providing module and a search-based providing module.

According to example implementations of the present disclosure, there is further comprised at least one of: a directed graph presenting module configured to present the causality in a directed acyclic graph, nodes in the directed acyclic graph representing the multiple variables, and an edge in the causality representing causality between two variables among the multiple variables; and a matrix presenting module configured to present the causality in a matrix, multiple dimensions in the matrix representing the multiple variables, and an element of the matrix representing a weight of causality between two variables, which correspond to the element, among the multiple variables.

According to example implementations of the present disclosure, the multiple variables represent multiple attributes of the application system.

According to example implementations of the present disclosure, the obtaining module 910 comprises: a receiving module configured to, regarding a given sample among the multiple samples, receive data of multiple dimensions included in the given sample from one or more sensors deployed in the application system, respectively.

According to example implementations of the present disclosure, there is further comprised at least any of: a performance providing module configured to improve performance of the application system based on the causality; and a troubleshooting module configured to eliminate failures in the application system based on the causality.

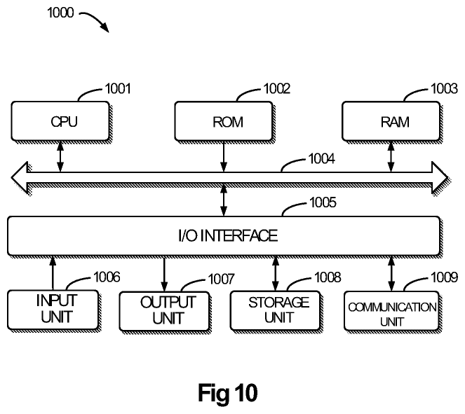

FIG. 10 shows a schematic block diagram of a device for information processing according to one implementation of the present disclosure. As depicted, the device 1000 includes a central processing unit (CPU) 1001, which can execute various suitable actions and processing based on the computer program instructions stored in the read-only memory (ROM) 1002 or computer program instructions loaded in the random-access memory (RAM) 1003 from a storage unit 1008. The RAM 1003 can also store all kinds of programs and data required by the operations of the device 1000. CPU 1001, ROM 1002 and RAM 1003 are connected to each other via a bus 1004. The input/output (I/O) interface 1005 is also connected to the bus 1004.

A plurality of components in the device 1000 are connected to the I/O interface 1005, including: an input unit 1006, such as a keyboard, mouse and the like; an output unit 1007, e.g., various kinds of displays and loudspeakers etc.; a storage unit 1008, such as a magnetic disk and optical disk, etc.; and a communication unit 1009, such as a network card, modem, wireless transceiver and the like. The communication unit 1009 allows the device 1000 to exchange information/data with other devices via the computer network, such as Internet, and/or various telecommunication networks.

The above described process and treatment, such as the methods 300 and 500 can also be executed by the processing unit 1001. For example, in some implementations, the methods 300 and 500 can be implemented as a computer software program tangibly included in the machine-readable medium, e.g., the storage unit 1008. In some implementations, the computer program can be partially or fully loaded and/or mounted to the device 1000 via ROM 1002 and/or the communication unit 1009. When the computer program is loaded to the RAM 1003 and executed by the CPU 1001, one or more steps of the above described methods 300 and 500 can be implemented.

According to example implementations of the present disclosure, an electronic device is provided, comprising: at least one processing unit; at least one memory, coupled to the at least one processing unit and storing instructions to be executed by the at least one processing unit, the instructions, when executed by the at least one processing unit, causing the device to perform the method described above.

According to example implementations of the present disclosure, a computer-readable storage medium is provided, containing computer-readable program instructions stored thereon which are used to perform the method described above.

The present disclosure can be a method, device, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but is not limited to, an electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where a remote computer is involved, the remote computer can be connected to the user computer via any type of network, including local area network (LAN) and wide area network (WAN), or to the external computer (e.g., connected via Internet using an Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow charts and/or block diagrams of method, apparatus (system) and computer program products according to implementations of the present disclosure. It should be understood that each block of the flow charts and/or block diagrams and the combination of various blocks in the flow charts and/or block diagrams can be implemented by computer-readable program instructions.

The computer-readable program instructions can be provided to the processing unit of a general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into a computer, other programmable data processing apparatuses or other devices, so as to execute a series of operation steps on the computer, the other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow charts and block diagrams in the drawings illustrate system architecture, functions and operations that may be implemented by system, method and computer program products according to a plurality of implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order depending on the functions involved. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

1. A method for information processing, comprising:
obtaining multiple samples associated with multiple variables in an application system, each sample among the multiple samples comprising multiple dimensions, the multiple dimensions corresponding to the multiple variables, and the multiple variables involving multiple data types;
determining an association associated with the multiple variables from the multiple samples based on the multiple data types, the association indicating an associated relationship between any two variables among the multiple variables; and
providing causality between the multiple variables based on the association and the multiple samples.

2. The method of claim 1, wherein the multiple data types comprise at least two of: continuous data type, ordinal data type, Boolean data type and censored data type.

3. The method of claim 1, wherein determining the association from the multiple samples based on the multiple data types comprises:
determining a first type of a first variable and a second type of a second variable among the multiple variables; and
determining an association element in the association which indicates an associated relationship between the first variable and the second variable, based on the first type and the second type.

4. The method of claim 3, wherein determining the association element based on the first type and the second type comprises: in response to the first type being determined as censored type, converting data which corresponds to the first variable, in the multiple samples into the ordinal data type.

5. The method of claim 4, wherein converting the data, which corresponds to the first variable, in the multiple samples into the ordinal type comprises:
determining a first dimension, which corresponds to the first variable, in the multiple samples; and
converting data in the first dimension into the ordinal data type according to a quantile in the data in the first dimension in the multiple samples.

6. The method of claim 5, wherein converting the data in the first dimension into the ordinal data type comprises:
determining the number of levels included in the ordinal data type according to at least any of: the number of the multiple samples and a range of the data in the first dimension;
determining at least one quantile associated with the number of the levels; and
converting the data in the first dimension into the ordinal data type based on the at least one quantile.

7. The method of claim 3, wherein determining the association element based on the first type and the second type comprises: in response to both the first type and the second type being determined as continuous data type, determining the association element based on a rank correlation solution.

8. The method of claim 3, wherein determining the association element based on the first type and the second type comprises: in response to both the first type and the second type being determined as ordinal data type, determining the association element based on a polychoric correlation solution.

9. The method of claim 4, wherein determining the association element based on the first type and the second type comprises: in response to the first type being determined as continuous data type and the second type being determined as ordinal data type,
converting data, which corresponds to the first variable, in the multiple samples into Gaussian distribution data; and
using a polyserial correlation solution to determine the association element based on the Gaussian distribution data and data of the ordinal data type.

10. The method of claim 1, wherein providing the causality based on the association comprises providing the causality by at least any of: a constraint-based solution and a search-based solution.

11. The method of claim 1, further comprising at least any of:
presenting the causality in a directed acyclic graph, nodes in the directed acyclic graph representing the multiple variables, and an edge in the causality representing causality between two variables among the multiple variables; and
presenting the causality in a matrix, multiple dimensions in the matrix representing the multiple variables, and an element of the matrix representing a weight of causality between two variables, which correspond to the element, among the multiple variables.

12. The method of claim 1, wherein the multiple variables represent multiple attributes of the application system.

13. The method of claim 12, wherein obtaining the multiple samples comprises: regarding a given sample among the multiple samples, receiving data of multiple dimensions included in the given sample from one or more sensors deployed in the application system, respectively.

14. The method of claim 13, further comprising at least any of:
improving performance of the application system based on the causality; and
eliminating failures in the application system based on the causality.

15-28. (canceled)

29. An electronic device, comprising:
at least one processing unit;
at least one memory, coupled to the at least one processing unit and storing instructions to be executed by the at least one processing unit, the instructions, when executed by the at least one processing unit, causing the device to perform a method, the method comprising:
obtaining multiple samples associated with multiple variables in an application system, each sample among the multiple samples comprising multiple dimensions, the multiple dimensions corresponding to the multiple variables, and the multiple variables involving multiple data types;
determining an association associated with the multiple variables from the multiple samples based on the multiple data types, the association indicating an associated relationship between any two variables among the multiple variables; and
providing causality between the multiple variables based on the association and the multiple samples.

30. A computer-readable storage medium, with computer-readable program instructions stored thereon, the computer-readable program instructions being used to perform a method, the method comprising:
obtaining multiple samples associated with multiple variables in an application system, each sample among the multiple samples comprising multiple dimensions, the multiple dimensions corresponding to the multiple variables, and the multiple variables involving multiple data types;
determining an association associated with the multiple variables from the multiple samples based on the multiple data types, the association indicating an associated relationship between any two variables among the multiple variables; and
providing causality between the multiple variables based on the association and the multiple samples.
